(19) United States
(12) Patent Application Publication
(10) Pub. No.: US 2012/0002210 A1
(43) Pub. Date: Jan. 5, 2012

(54) OPTICAL INTERFEROMETER

(75) Inventors: Hans Villemoes Andersen, Hillerod (DK); Bjarne Mølsted, Stenlose (DK); Sussie My Nikolajsen, Slangerup (DK)

(73) Assignee: Foss Analytical A/S, Hilleroed (DK)

(21) Appl. No.: 13/138,596

(22) PCT Filed: Apr. 28, 2009
(86) PCT No.: PCT/EP2009/055123

§ 371 Date: Sep. 9, 2011

(51) Int. Cl. G01B 9/02

(52) U.S. Cl. 356/450

(57) ABSTRACT

A scanning optical interferometer (40) having a beamsplitter (42); a first input path (56) for an observation beam (52) and a second input path (78) for a reference beam (76) wherein both paths (56; 78) are directed towards the same beamsplitter (42) characterised in that the interferometer is configured with the first input path (56) and the second input path (78) intersecting at a location (L) before the beamsplitter (42) and in that the interferometer further comprises a dichroic filter (80) located at the intersection (L) of the two paths (56; 78) and acting to collocate both paths (56;78) in a direction towards the beamsplitter (42).

The present invention relates to an optical interferometer, in particular to a scanning interferometer and more particularly to a scanning interferometer operating according to the Michelson principle or a principle derived there from (generally referred to in this specification as a ‘Michelson type’ interferometer).

Known scanning interferometers, such as those of the Michelson type, generally comprise two or more reflectors, such as mirrors or retro-reflectors, and a beamsplitter with at least one of the reflectors being arranged to be reciprocally movable. An observation beam, generally consisting of radiation in a wavelength region of interest either before or after its interaction with a sample material, enters the interferometer and strikes the beamsplitter. This beam is split into essentially two equal parts at the beamsplitter. A first beam is reflected by the beamsplitter and travels along a first ‘arm’ to the first reflector. A second beam passes through the beamsplitter and travels along a second ‘arm’ to the second reflector.

The first beam is reflected by the first reflector, passes back along the first arm, through the beamsplitter, and continues to a detector. Meanwhile, the second beam is reflected by the second reflector, passes back along the second arm, returns to the beamsplitter, and is also reflected to the detector. An interference pattern (interferogram) is then recorded by the detector as the one or more reflectors are moved to create cyclic excursions of the related optical path and hence a cyclic optical path length difference between the first and the second beams. As a result of this interference each wavelength in the observation beam is modulated at a different frequency. Spectral information may then be extracted from the interferogram by numerically performing a Fourier transform (FT).

In the recording of an interferogram, particularly when using the so-called Fast FT technique, the sampling at exact equidistant positions of the moving reflector is critical for avoiding error. However the movement of the reflector with sufficiently low variation requires the use of very expensive actuators, and therefore it has become practice in FT spectroscopy to use a source of radiation of known wavelength, such as a laser, to generate a reference beam in a reference FT interferometer. This reference FT interferometer operates in parallel to the FT interferometer used for monitoring the observation beam (the principle interferometer) in order to generate a reference interferogram. The wavelength of the reference source is accurately known and the parallel operation means that the movable reflector of the reference FT interferometer is made to move in a known relationship with that of the principle FT interferometer. Features, such as zero crossing positions, of the reference interferogram can therefore be employed to accurately determine the incremental displacement and/or velocity of the movable reflector in the principle FT interferometer. Thus the sampling frequency for the observed radiation may be accurately determined. However, the use of a separate reference interferometer which is mechanically coupled to the principle FT interferometer adds considerably to the cost and the complexity of the system. It has therefore become practice to obtain the reference interferogram directly through the principle interferometer by employing a reference source and associated detector chosen to operate at a wavelength outside and below the wavelength region of the radiation constituting the observation beam. It is common practice to select a reference source which emits at a wavelength satisfying the Nyquist sampling criterion, requiring the sampling frequency to be at least twice the frequency of the observed signal.

In the known interferometers of the type in which the reference interferogram is obtained in the principle interferometer the optical path for the observation beam through the interferometer and the optical path for the reference beam through the interferometer include the same optical components. However the actual optical paths through these components may be substantially different. This results in each beam interacting with a different portion of these optical components. This has the disadvantage that the optical components must be made large enough to accommodate the two distinct optical paths. Moreover, the reference beam typically interacts with the edges of the optical components which, for movable components at least, could mean that there is a difference between the movement monitored by the reference beam and that experienced by the observation beam.

According to one aspect of the present invention there is provided an optical interferometer as described in and characterised by the present Claim 1. By using a suitably disposed dichroic filter both the optical path for the observation beam and that for the reference beam are collocated, usefully in co-location. This has the advantage that both beams interact with substantially the same portions of the optical components which are common to both the observation beam and the reference beam. This results in the possibility to reduce the size of these optical components and hence the opportunity to provide a more compact interferometer. Moreover, the reference beam more accurately represents any changes in the light path through these components which may be experienced by the observation beam.

These and other advantages will become apparent from a consideration of the following description of exemplary embodiments made with reference to the drawings of the accompanying figures, of which:

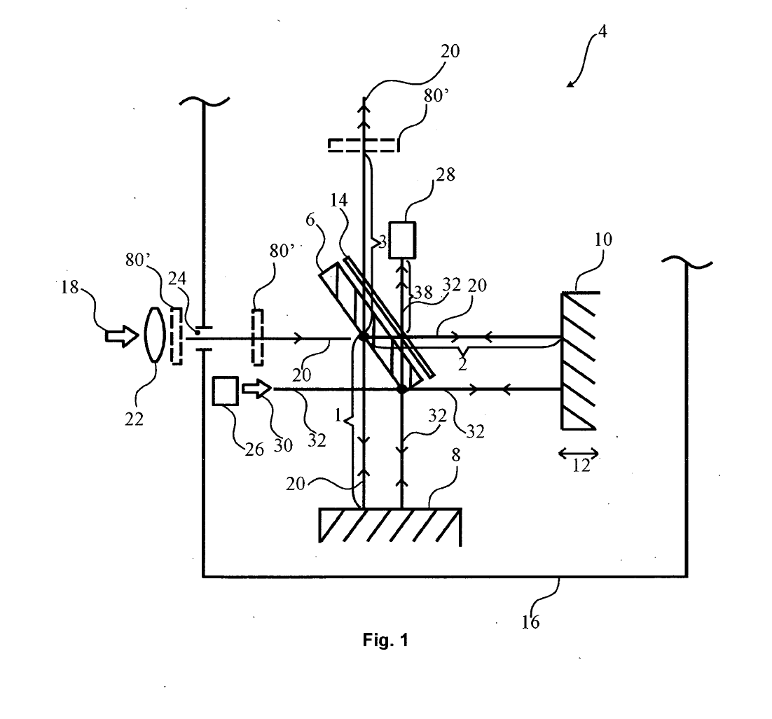

FIG. 1 shows a prior art scanning interferometer of the Michelson type;

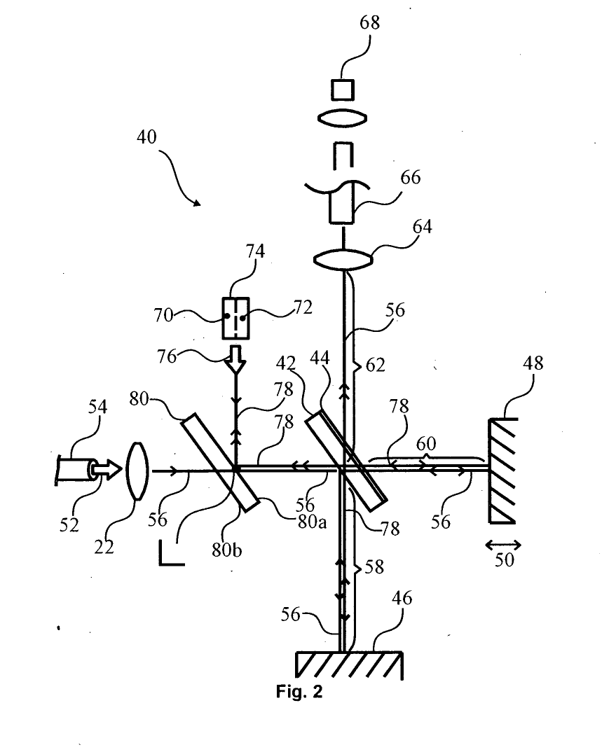

FIG. 2 shows schematically a scanning interferometer of the Michelson type according to the present invention;

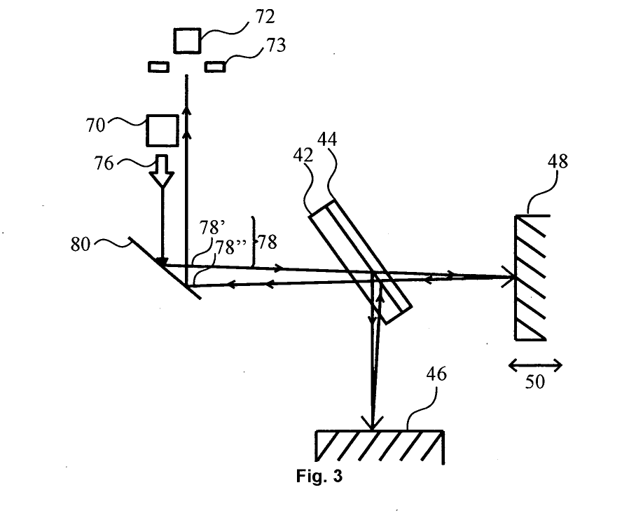

FIG. 3 shows detail of the optical path for the reference beam through the interferometer of FIG. 2;

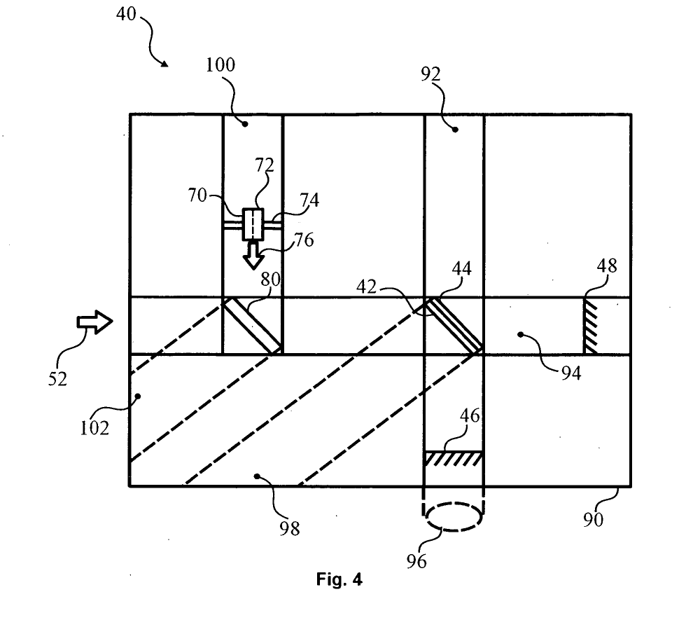

FIG. 4 shows an interferometer according to the present invention with a block housing configuration;

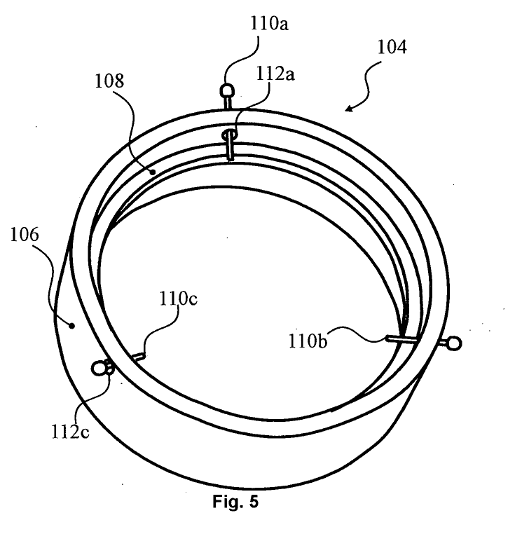

FIG. 5 shows an optical mount suitable for use in the interferometer of FIG. 4; and

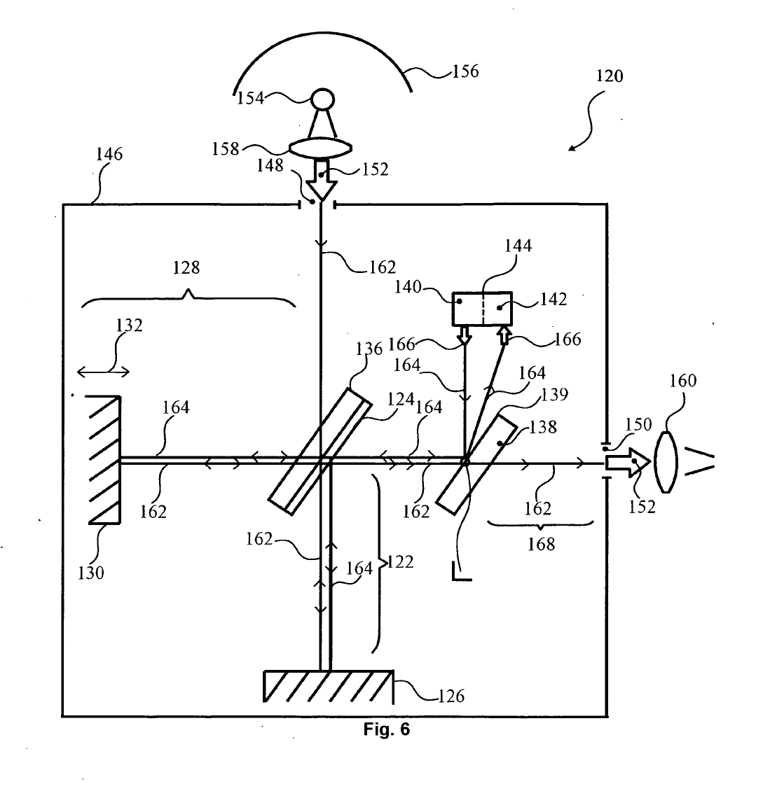

FIG. 6 shows schematically a further embodiment of a scanning interferometer according to the present invention;

Referring now to FIG. 1 a prior art scanning interferometer 4 of the Michelson type is illustrated. Its principle of operation is well known and so the interferometer 4 will be described only in such detail as is necessary for an understanding of the present invention. The interferometer 4 of the present example comprises a beamsplitter 6 and two reflectors here in the form of plane-mirrors 8,10. One mirror is a reciprocally movable mirror 10 (illustrated by the double headed arrow 12) and the other mirror 8 is fixed. A compensator 14 is often, but not necessarily, included as an optical component of the interferometer 4 and when included is normally mounted together with the beamsplitter 6. These optical components 6, 14 are enclosed in an interferometer housing 16 together with the two reflectors 8,10. The beamsplitter 6 and the fixed mirror 8 are arranged to together define a first ‘arm’ 1 and the beamsplitter 6 and the movable mirror 10 are arranged to together define a second arm 2. Cyclic excursions in the length of the second arm 2 are generated, in the present example, by reciprocating movement of the mirror 10.

An observation beam 18 is caused to traverse a first path 20 which divides at the beamsplitter 6 along the first 1 and the second 2 arms to be reflected by respectively the fixed mirror 8 and the movable mirror 10. In the present example a suitable lens 22 generates a parallel observation beam 18 which passes into the interferometer 4 through an entrance aperture 24 in the housing 16 to traverse the first optical path 20. Other means of introducing the observation beam 18 into the interferometer 4, such as for example an arrangement including a fibre optical guide, will be well known to the person skilled in the art.

Also illustrated as part of the known scanning interferometer 4 of FIG. 1 is a reference radiation source 26 and complementary detector 28 arrangement which generates and detects a beam 30 of substantially monochromatic reference radiation at a wavelength outside and below the wavelength region of the observation beam 18. It will also be appreciated by the skilled person that such a reference beam 30 can be initially generated and/or finally detected outside of the interferometer housing 16.

In the known scanning interferometer 4 the reference beam 30 is caused to traverse a second optical path 32 which includes the beamsplitter 6 and the fixed 8 and movable 10 mirrors. This second optical path 32 is essentially parallel to but substantially laterally displaced from the first optical path 20.

In use the observation beam 18 traverses the first optical path 20 to be split into two substantially identical partial beams. One partial beam will traverse that portion of the first optical path 20 along the first arm 1 to be reflected from the fixed mirror 8 to traverse the same first arm 1 towards the beamsplitter 6. The other partial beam will traverse that portion of the first optical path 20 extending along the second arm 2 to be reflected from the movable mirror 10 back along the same second arm 2 towards the beamsplitter 6. The partial beams recombine at the beamsplitter 6 and traverse a common portion 3 of the first optical path 20 towards a detector (not shown). Simultaneously, the reference beam 30 traverses the second optical path 32 and is similarly split into two substantially identical partial beams. One partial beam will traverse that portion of the second optical path 32 which extends along the first arm 1 and the other partial beam will traverse that portion of the second optical path 32 which extends along the second arm 2. The second optical path 32 travelled by the reference beam 30 between the beamsplitter 6 and the two mirrors 8,10 is substantially parallel to but significantly laterally displaced from first optical path 20 traversed by the partial beams originating from the observation beam 18. Upon reflection from the corresponding mirrors 8,10 the two partial beams derived from the reference beam 30 will recombine at the beamsplitter 6 to traverse a common portion 38 of the second optical path 32 towards the detector 28. The interference pattern (interferogram) that is registered at the detector 28 and which is consequent on the reciprocating movement of the mirror 10 may then be employed to monitor the movement of that mirror 10.

A dichroic filter 80′ is often also a component of the known interferometer 4 where it is employed to prevent shorter wavelengths (that is wavelengths shorter than those of the observation beam 18) from reaching the detector (not shown). Such shorter wavelengths may be generated by stray ambient light reaching the entrance aperture 24 of the interferometer 4. In order to achieve this filtering the filter 80′ is located in the first optical path 20 for the observation beam 18 either before or after the beamsplitter 6. Suitable positions of the filter 80′ are illustrated by the broken lined constructions in FIG. 1.

Considering now an exemplary embodiment of a Michelson type interferometer 40 according to the present invention which is illustrated in FIG. 2. In common with the known interferometer 4 of FIG. 1, the exemplary interferometer 40 according to this embodiment of the present invention comprises a beamsplitter 42, an associated compensator 44 and two reflectors which for the sake of ease of description are again illustrated as plane-mirrors 46, 48. One of mirrors 46 is, in the present embodiment, fixed whilst the other mirror 48 is reciprocally movable along the directions illustrated by the arrow 50.

As with the known interferometer of FIG. 1, an observation beam 52 (here illustrated as passing from a fibre optic 54) is caused to traverse a first optical path 56 that intersects the beamsplitter 42. The observation beam 52 is then split and one part is caused to traverse a first arm 58, terminating with the fixed mirror 46 whilst a second part is caused to traverse a second arm 60 which terminates at the movable mirror 48. The partial beams traversing the arms 58,60 recombine at the beamsplitter 42 to traverse a common portion 62 of the first optical path 56 towards a detection means (here illustrated as comprising a collection lens 64, associated fibre optic 66 and a optically coupled detector 68).

Similar to the known interferometer 4, the exemplary interferometer 40 according to the present invention also comprises a reference radiation source 70 and complimentary detector 72 arrangement. Different to the known interferometer 4, the interferometer 40 is configured such that a beam of reference radiation 76 will traverse a second optical path 78 that intersects the first optical path 56 for the observation beam 52 at a location (generally indicated by L) that, in the present embodiment, is before the beamsplitter 42.

A dichroic filter 80 is included as an element of the interferometer 40 and is located in the region of the location of the intersection L to interact with both the observation beam 52 and the reference beam 76 and thereby collocate associated first 56 and second 78 optical paths in a common direction towards the beamsplitter 6. This results in the first 56 and the second 78 optical paths intersecting substantially the same regions of the optical elements 42,46,48 which delimit the first 50 and the second 60 arms of the interferometer 40. This has an advantage that these optical elements can be reduced in size as compared with those of the known interferometer of FIG. 1. Moreover, a further advantage is that the accuracy is improved since the reference beam 76 monitors the mirror 48 movement centrally. It will also be appreciated that dichroic filter 80 may, in this location, additionally perform the function of stopping shorter wavelengths as does the dichroic filter 80′ of the known interferometer 4.

The dichroic filter 80 is selected to, in use, permit the transmission of one or other of the observation beam 52 and the reference beam 76 (in the present embodiment the observation beam 52) substantially unhindered whilst reflecting the other (here the reference beam 76) beam.

According to the exemplary embodiment of FIG. 2 the dichroic filter 80 is disposed in the interferometer 40 with a first surface 80a on which the reference beam 76 will be incident and will be reflected towards the beamsplitter 42 and with a second, opposing surface 80b on which the observation beam 52 will be incident and transmitted towards the beamsplitter 42. In a particular application the observation beam 52 consists of radiation in the infra-red region and the reference radiation beam 76 comprises a substantially monochromatic beam in the visible region, for example radiation at a wavelength of 670 nm (±20 nm) originating from a VCSEL or other laser source 70. When passing through the interferometer 40 configured as illustrated in FIG. 2 then the dichroic filter 80 will be a so-called ‘cold mirror’. It will be appreciated that the interferometer 40 may be configured so that the observation beam 52 is incident on and reflected by the first surface 80a of the dichroic filter 80 and the reference beam 76 is incident on and transmitted through the opposing surface 80b of the dichroic filter 80. In this embodiment the dichroic filter 80 will then be a so-called ‘hot mirror’.

The optical path 78 for the reference beam 76 through the interferometer of FIG. 2 is illustrated in more detail in FIG. 3. It can be seen that the source 70 is angled relative to the dichroic filter 80 such that the reference beam 76 actually traverses two slightly displaced optical paths 78′ and 78″ as it travels to and from the moving reflector 48 and to and from the fixed reflector 46. This slight angular displacement permits the complimentary detector 72 (in the present embodiment also shown to comprise pin-hole entrance aperture 73) to be located in close proximity to the source 70 and contributes to a more compact construction of the interferometer 40.

An example of such a compact construction of the interferometer 40 is illustrated in FIG. 4. A housing 90 is provided as a block, in the present embodiment formed from a single piece of material such as aluminium or a hard plastics material, in to which holes are machined, as will be described in more detail below. It will be appreciated that in other embodiments the housing 90 may be formed from a multiple of components which, when assembled, cooperate to provide the necessary bores.

In the present embodiment two bore holes 92, 94 are made at an angle, here substantially 90°, to one another and pass through the block 90. At the intersection of the two through bores 92,94 is positioned the beamsplitter 42 and compensator 44 arrangement. This beamsplitter arrangement 42,44 is to be located using a third bore 98 (illustrated by hatched line) which is provided at substantially 45° to the two through bores 92,94 and out of the plane of the figure. A fourth bore 100 is provided in the block 90 to intersect the through bore 94 at a location at which a dichroic filter (80) is to be introduced via a fifth bore 102. This fifth bore 102 intersects bores 94 and 100 at substantially 45°. The fourth bore 100 is provided to receive the mount 74 holding the reference source 70 and associated detector 72. A fixed reflector 46 and movable reflector 48 may be introduced into the associated through-bores 92, 94.

Some or all of the bore holes 92, 94, 102 may be advantageously provided with an elliptical cross-section (as illustrated by the broken line 96 with respect to the through bore 92). This ensures maximal material support for the optical and mechanical elements whilst providing minimum interference of the light beams through the interferometer which is elliptically shaped by the projection of the 45° beamsplitter arrangement 42,44.

In this arrangement the observation beam 52 enters the housing 90 via the through bore 94 at an end opposite the movable reflector 48 and intersects the beam of reference radiation 76 at substantially 90°. The dichroic filter 80 is located at this intersection and bisects the angle between the two beams 52, 76 to generate a common path for both beams 52, 76 towards the beamsplitter arrangement 42,44.

A suitable holder for optical components such as the beamsplitter arrangement 42,44 and the dichroic filter 80 of the compact interferometer illustrated in FIG. 4 is shown in FIG. 5. The holder 104 comprises a cylindrical circumferential holder 106 having an inwardly projecting support, here in the form of circumferential support surface or lip 108, against which the optical component, for example the dichroic filter 80 or beamsplitter arrangement 42,44 say, is intended to rest. This support surface or lip 108 may, as illustrated in the present embodiment, extend around the entire inner circumference of the holder 106 or may be broken to form a plurality (usefully three) supporting seats. The holder 106 has an outer circumferential dimension sized to slidably engage with and be slightly compressed by the appropriate bore 92,94,100,102 of the block housing 90.

Biasing means, here in the form of ‘pins’ 110a, 110b and 110c made from small gauge wire such as piano wire, are provided to slidably engage with and to urge the optical element in to contact with the inwardly projecting support means 108 of the holder 106. A corresponding hole, 112c say, is provided for each pin, 110c say, through the holder 106 at an angle for directing the pin 110c towards the inwardly projecting support means 108. The relatively small biasing means 110a-c as compared to that used in traditional optical mounts provides a relatively larger optical aperture of the supported optical element, allowing a smaller optical element to be employed. The strong springs provided by the pins 110a,b,c will yield low sensitivity towards vibration but, as they slidably engage with the optical element, will still allow for material response to compressional and thermal variations without distorting the optical element 80,42,44.

A further embodiment of an interferometer 120 according to the present invention is shown schematically in FIG. 6. The interferometer 120 is formed with a first arm 122, being defined by a beamsplitter 124 and a fixed reflector 126, and a second arm 128, being defined by the beamsplitter 124 and a movable reflector 130. The interferometer 120 further comprises a compensator 136, a dichroic filter 138 and a reference source 140 and detector 142 arrangement 144, which components are housed together with the beamsplitter 124 and the reflectors 126,130 in a housing 146. The housing 146 is provided with an entrance aperture 148 and an exit aperture 150 through which an observation beam 152 respectively enters and exits the interferometer 120. Also illustrated in FIG. 6 is a source 154 and reflector 156 for the generation of the observation beam 152 as well as focussing lenses 158, 160 associated with the entrance aperture 148 and the exit aperture 150 respectively.

As with the interferometers 4 and 40 previously described, the observation beam 152 enters the interferometer 120 to follow a first optical path 162 through the interferometer 120. The beamsplitter 124 intersects this first optical path 162 and causes two partial observation beams to each traverse an associated portion of the first optical path 162 along respective first 122 and second 128 arms of the interferometer 120. After these partial beams recombine at the beamsplitter 124 the observation beam 152 traverses a common portion 168 of the first optical path 162 towards the exit aperture 150.

The reference source 140 is, in the present embodiment, located within the interferometer 120 to generate a reference beam 166 which traverses a second optical path 164 to intersect the first optical path 162 for the observation beam 152 substantially at right angles and at a location L between the beamsplitter 124 and the exit aperture 150. The dichroic filter 138 is located in the region of the intersection L.

The filter 138 is configured to pass the observation beam 162 that is incident on a first surface 139 whilst reflecting the reference beam 166, which is also incident on the first surface 139. The filter 138 causes the reference beam 166 from the reference source 140 to traverse the second optical path 164 to the beamsplitter 124 where it then traverses the portions of the second optical path 164 that extend between the two arms 122, 128. After recombining at the beamsplitter 124 the reference radiation beam 166 traverses the second optical path 164 towards the dichroic filter 138. The filter 138 acts to reflect this reference beam 166 along a bifurcation (exaggerated in the FIG. 6. for clarity) in the second optical path 164 towards the detector 142.

As will be appreciated and in common with the embodiment of the interferometer 40 according to the present invention illustrated in FIG. 2, The dichroic filter 138 acts to essentially collocate those portions of the first 162 and the second 164 optical paths that have optical elements of the interferometer 120 in common. In the present embodiment these optical elements are the beamsplitter 124; the compensator 136 and the two reflectors 126,130. It will also be appreciated that the embodiment of the interferometer 120 which is described in relation to FIG. 6 may be realised in a block construction similar to that described in relation to FIG. 4.

1. A scanning optical interferometer having a beamsplitter; a first optical path for an observation beam and a second optical path for a reference beam wherein the interferometer is configured with the beamsplitter intersecting both the first optical path and the second optical path wherein the interferometer is further configured with the first optical path and the second optical path intersecting at a location (L) and in that the interferometer further comprises a dichroic filter located in the region of the intersection (L) so as to collocate both the first optical path (56;162) and the second optical path.

2. A scanning interferometer as claimed in claim 1 wherein the dichroic filter is arranged to bisect the angle formed between the first optical path and the second optical path at the intersection (L).

3. A scanning interferometer as claimed in claim 1 wherein the dichroic filter is disposed to reflect a one of the reference beam and the observation beam incident on a first surface and to transmit the other of the observation beam and the reference beam being incident on a second, opposing surface to collocate both optical paths.

4. A scanning interferometer as claimed in claim 1 wherein the dichroic filter is disposed to reflect the reference beam and to transmit the observation beam, both being incident on a first surface, to collocate both paths.

5. A scanning interferometer as claimed in claim 1 wherein the interferometer is configured with the first optical path and the second optical path intersecting substantially at right angles to one another at the location (L).

6. A scanning interferometer as claimed in claim 1 wherein it further comprises a housing formed as a block having bores disposed therein for receiving optical elements selected from at least the beamsplitter; the dichroic filter and fixed and moving reflectors.

7. A scanning interferometer as claimed in claim 6 further comprising an optical mount for at least one of the optical elements comprising the interferometer, wherein the optical mount comprises a holder having an inner projection and biasing pins for urging and maintaining the optical element in to contact with the inner projection.

8. A scanning interferometer as claimed in claim 1 further comprising a fixed and a movable reflector, each disposed relative to the beamsplitter to define in conjunction therewith respectively a first and a second arm delimiting portions of both the first optical path and the second optical path wherein the dichroic filter is disposed to collocate both the first optical path and the second optical path along both the first arm and the second arm.
